(19) United States
(12) Patent Application Publication
(10) Pub. No.: US 2009/0101258 A1
(43) Pub. Date: Apr. 23, 2009

(54) Pneumatic Tire

(75) Inventor: Norihiko NAKAMURA, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/249,045

(22) Filed: Oct. 10, 2008

(30) Foreign Application Priority Data
Oct. 18, 2007 (JP) 2007-271084

(51) Int. Cl. B60C 1/00

(52) U.S. Cl. 152/209.5

(57) ABSTRACT

A pneumatic tire using a rubber composition that can reduce rolling resistance of a tire and promote low fuel consumption in a base rubber is provided. The pneumatic tire includes a tread rubber which comprises a cap rubber provided at a road surface side and a base rubber provided at its inner periphery side, wherein the base rubber comprises a rubber composition which comprises 100 parts by weight of a diene rubber component containing from 15 to 50 parts by weight of a butadiene rubber or a styrene-butadiene rubber, its molecular end being modified with a modifier, polymerized using an organic lithium catalyst, and from 20 to 50 parts by weight of carbon black having a nitrogen adsorption specific surface area (N₂SA) of from 20 to 40 m²/g and a dibutyl phthalate (DBP) absorption of from 50 to 150 cm³/100 g, and loss tangent (tan δ) of the rubber composition measured at 70° C is less than 0.05.

### CROSS-REFERENCE TO RELATED APPLICATION

This application is based upon and claims the benefit of priority from the prior Japanese Patent Application No. 2007-271084, filed on Oct. 18, 2007; the entire contents of which are incorporated herein by reference.

### BACKGROUND

The present invention relates to a pneumatic tire, and more particularly it relates to a pneumatic tire having a tread of a cap/base structure, and suppressing generation of heat of a rubber composition by using an end-modified polymer and a specific carbon black in combination in a base rubber, thereby improving low fuel consumption of tires.

In recent years, reducing rolling resistance of a pneumatic tire and improving fuel consumption of vehicles are strongly required as social demands.

Regarding the improvement in low fuel consumption of a pneumatic tire, a rubber composition using a diene rubber or a diene polymer end-modified with a specific modifier and carbon black having specific colloidal characteristics, in combination, and setting tan δ to a specific range has conventionally been proposed, and reducing rolling resistance by using the rubber composition in a tread, thereby improving low fuel consumption is described in, for example, JP-A-9-227720 (kokai), JP-A-11-209518 (kokai) and JP-A-2005-68208 (kokai), the entire contents of those references being incorporated herein by reference.

As a result of focusing attention to a base rubber of a tread having a cap/base structure to reduce rolling resistance, it has been found that the base rubber has small influence on running performances such as abrasion resistance, driveability or wet performance as compared with a cap rubber, and rolling resistance can be reduced without impairing tire performances by greatly reducing hysteresis loss of the base rubber.

In view of the above, as a result of various investigations on a rubber composition of the base rubber, it has been found that rolling resistance of a tire can be reduced without impairing fracture strength and fatigue resistance required as a base rubber and additionally without impairing processability, by combining a molecular end-modified butadiene rubber or styrene-butadiene rubber obtained by polymerization using a lithium catalyst as a rubber component, and carbon black having specific colloidal characteristics.

### SUMMARY

According to the aspect of the present invention, there is provided a pneumatic tire using a rubber composition that can reduce rolling resistance of a tire and promote low fuel consumption in a base rubber.

The present invention may provide a pneumatic tire comprising a tread rubber which comprises a cap rubber provided at a road surface side and a base rubber provided at its inner periphery side, wherein the base rubber comprises a rubber composition which comprises 100 parts by weight of a diene rubber component containing from 15 to 50 parts by weight of a butadiene rubber or a styrene-butadiene rubber, its molecular end being modified with a modifier, polymerized using an organic lithium catalyst, and from 20 to 50 parts by weight of carbon black having a nitrogen adsorption specific surface area (N₂SA) of from 20 to 40 m²/g and a dibutyl phthalate (DBP) absorption of from 50 to 150 cm³/100 g, and loss tangent (tan δ) of the rubber composition measured at 70° C. is less than 0.05.

According to the aspect of the present invention, a pneumatic tire having improved low fuel consumption by reducing rolling resistance of a tire without impairing other tire performances can be provided.

### BRIEF DESCRIPTION OF THE DRAWINGS

FIG. 1 is a half sectional view of a tread showing one example of a pneumatic tire of the embodiments.

### DETAILED DESCRIPTION

The embodiments of the present invention are described below.

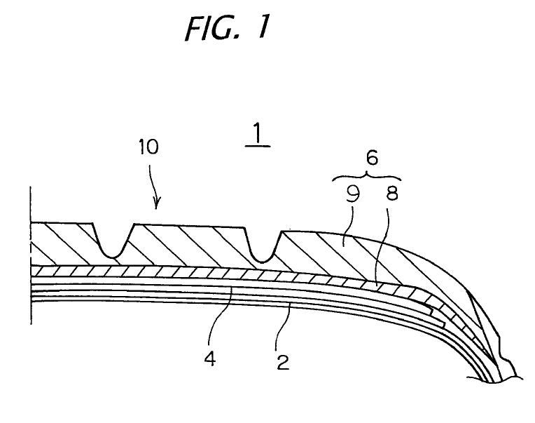

FIG. 1 is a half sectional view of a tread showing one example of a pneumatic tire according to the embodiments of the present invention. A pneumatic tire 1 comprises a pair of beads, a side wall extending outwardly in each radial direction of a tire from the beads (beads and side wall are not shown), and a tread 10 provided between the side walls. This structure is the same structure as in a general tire. The embodiments of the present invention can be applied to any tires having such a structure.

The pneumatic tire 1 has a carcass layer 2 which is provided so as to be bridged between a pair of beads. The carcass layer 2 is a radial carcass formed from a code layer obtained by rubberizing a code of a polyester or the like. A belt layer 4 reinforcing the tread 10 by hoop effect is provided at an outer side in a tire radial direction of the carcass layer 2, and the tread 10 is formed at the outer side of a tire radial direction of the belt layer 4. A tread rubber 6 has a so-called cap/base structure comprising a cap rubber 9 provided at a road surface side and a base rubber 8 provided at an inner periphery thereof.

The rubber composition used in the base rubber is that as the rubber component, a modified rubber having a molecular end modified with a modifier, which is a butadiene rubber (BR) or a styrene-butadiene rubber (SBR) polymerized using an organic lithium catalyst is used in an amount of from 15 to 50 parts by weight in the rubber component, and other diene rubber other than the modified BR and the modified SBR is used as a remainder of the rubber component.

The organic lithium compound used as a polymerization catalyst of BR or SBR is an organic lithium compound generally used in a solution polymerization, and its kind is not particularly limited. Examples of the organic lithium compound include alkyl lithium represented by methyl lithium, ethyl lithium, propyl lithium, n-butyl lithium, sec-butyl lithium, tert-butyl lithium, n-hexyl lithium or n-octyl lithium; aryl lithium represented by phenyl lithium, tolyl lithium or lithium naphthylide; alkenyl lithium represented by vinyl lithium or propenyl lithium; and alkylene dilithium represented by tetramethylene dilithium, pentamethylene dilithium, hexamethylene dilithium or decamethylene dilithium.

The modified BR and modified SBR are that a molecular end thereof is modified with a modifier. Examples of the modifier include a tin compound, and a compound containing a hydroxyl group, an amino group, an epoxy group, a cyano group, a carboxyl group, a halogen, an alkoxy group or the like. In the modified BR and modified SBR, a tin compound, a hydroxyl group, an amino group, an epoxy group, a cyano group, a carboxyl group, a halogen atom, an alkoxy group or the like is introduced into a polymer end of BR and SBR by modification. The degree of modification is 20% or more, and preferably 40% or more. The preferred modifier is a tin compound, a hydroxyl group-containing compound or an amino group-containing compound.

Examples of the tin compound include tin halide compounds such as tin tetrachloride, tin methyl trichloride, dibutyldichlorotin or tributylchlorotin; allyl tin compounds such as tetraallyltin, diethyldiallyltin or tetra (2-octenyl) tin; tetraphenyltin and tetrabenzyltin. The tin halide compounds are particularly preferred.

The compounding amount of the modified BR and the modified SBR is from 15 to 50 parts by weight per 100 parts by weight of the rubber component. Where the compounding amount is less than 15 parts by weight, an effect of reducing rolling resistance is small, and where the compounding amount exceeds 50 parts by weight, a Mooney viscosity tends to rise and processability tends to deteriorate.

Polymerization method and end modification method of the polymer can be conducted according to the conventional methods, and the methods described in, for example, JP-A-2002-284930 (kokai) and JP-A-2002-284933 (kokai), the entire contents of those references being incorporated herein by reference, can be used.

The other diene rubber is not particularly limited, and examples thereof include a natural rubber, and a synthetic diene rubber such as an isoprene rubber and a butadiene rubber or a styrene-butadiene rubber other than above, which are polymerized by a solution polymerization or an emulsion polymerization. Those may be used alone or as mixtures of two or more thereof, as the rubber component.

The rubber composition used in the base rubber comprises 100 parts by weight of a rubber component comprising a blend of the modified BR or SBR and other diene rubber, and from 20 to 50 parts by weight of carbon black having a nitrogen adsorption specific surface area (N₂SA) of from 20 to 40 m²/g and a dibutyl phthalate (DBP) absorption of from 50 to 150 cm³/100 g.

Where the N₂SA of the carbon black is less than 20 m²/g, tear force deteriorates due to the decrease in strength of the rubber composition, and durability deteriorates. On the other hand, where the N₂SA exceeds 40 m²/g, hysteresis loss is increased, and as a result, rolling resistance and generation of heat are increased. Furthermore, where the DBP absorption is less than 50 cm³/100 g, tear force deteriorates due to the decrease in strength. On the other hand where the DBP absorption exceeds 150 cm³/100 g, rolling resistance is not improved. The N₂SA and the DBP absorption are values measured according to JIS K6217.

The compounding amount of the carbon black is from 20 to 50 parts by weight per 100 parts by weight of the rubber component. Where the compounding amount of the carbon black is less than 20 parts by weight, reinforcement effect is deficient and tear resistance deteriorates. On the other hand, where the compounding amount of the carbon black exceeds 50 parts by weight, heat build-up deteriorates, and an effect of reducing rolling resistance is not obtained. Furthermore, processability tends to deteriorate.

Other than the components described above, various additives generally used in a rubber composition for tire, such as inorganic fillers (such as silica), age resisters, zinc white, stearic acid, softeners, vulcanizing agents or vulcanization accelerators can be used in the rubber composition according to the aspect of the present invention in a range that the advantage of the present invention is not impaired.

The rubber composition by the above constitution has a loss factor (tan δ) of less than 0.05 measured at an initial strain of 10%, a dynamic strain of 2%, a frequency of 10 Hz and a temperature of 70° C. according to JIS K-6394.

Where tan δ is 0.05 or more, energy loss is increased, and an effect of reducing rolling resistance is not achieved. The lower limit of tan δ is not particularly limited, but it is preferred to be 0.015 or more.

The rubber composition comprising the above each component is prepared using a kneading machine for rubber, such as Banbury mixer or a kneader, by the conventional methods.

The pneumatic tire according the aspect of the present invention can reduce rolling resistance of a tire, thereby improving low fuel consumption of a pneumatic tire, by applying the rubber composition described above to a base rubber.

### EXAMPLES

The examples of the present invention are specifically described below, but the invention is not limited to those examples.

A natural rubber (RSS#3) and each of butadiene rubbers (BR1 to BR3) shown below as rubber components, each carbon black (CB1 to CB5) shown below, and the common components in each rubber composition were kneaded by the conventional method using Banbury mixer having a volume of 200 liters to prepare a rubber composition of each of Examples and Comparative Examples. The rubber component, carbon black and common compounding components used are as follows.

### Rubber Component

Natural rubber (NR): RSS#3, made in Thailand

Butadiene rubber (BR1): BR01, manufactured by JSR Corporation

Tin-modified butadiene rubber (BR2): BR1250H, manufactured by Nippon Zeon Co., Ltd.

Hydroxyl-modified butadiene rubber (BR3): TUFDENE E40, manufactured by Asahi Kasei Corporation

### Carbon Black

Carbon black (CB1): SEAST SO (N₂SA=42 m²/g, DBP absorption=115 cm³/100 g), manufactured by Tokai Carbon Co., Ltd.

Carbon black (CB2): SEAST SVH (N₂SA=32 m²/g, DBP absorption=140 cm³/100 g), manufactured by Tokai Carbon Co., Ltd.

Carbon black (CB3): SEAST V (N₂SA=23 m²/g, DBP absorption=51 cm³/100 g), manufactured by Tokai Carbon Co., Ltd.

Carbon black (CB4): SEAST TA (N₂SA=19 m²/g, DBP absorption=42 cm³/100 g), manufactured by Tokai Carbon Co., Ltd.

Carbon black (CB5): SEAST FY (N₂SA=29 m²/g, DBP absorption=152 cm³/100 g), manufactured by Tokai Carbon Co., Ltd.

### Common Component

3 parts by weight of aroma oil (PROCESS X140, manufactured by Japan Energy Corporation), 1 part by weight of an age resister (NOCLAC 6C, manufactured by Ouchi Shinko Chemical Industrial Co., Ltd.), 2 parts by weight of stearic acid (RUNAX S-20, manufactured by Kao Corporation), 3 parts by weight of zinc white (Zinc White #1, manufactured by Mitsui Mining & Smelting Co., Ltd.), 2 parts by weight of sulfur (5% oil-treated powdery sulfur, manufactured by Hosoi Chemical Industry Co., Ltd.), and 1.5 parts by weight of a vulcanization accelerator (NOCCELLAR NS-P, manufactured by Ouchi Shinko Chemical Industrial Co., Ltd.) were compounded and used as the common components in each rubber composition.

Regarding the rubber compositions obtained, a Mooney viscosity as a processability, tear force and loss factor (tan δ) were evaluated by the following methods. The results obtained are shown in Table 1.

### Processability (Mooney Viscosity)

Mooney viscosity (ML₁₊₄) at 100° C. was measured according to JIS K6300, and indicated by an index as Comparative Example 1 being 100. The processability is better as the value is smaller.

### Tear Force

Tear strength was measured according to JIS K6251, and indicated by an index as Comparative Example 1 being 100. The tear force is stronger as the value is larger.

Loss factor (tan δ)

Using rheospectometer E4000, manufactured by UBM, dynamic modulus tan δ was measured under the conditions of an initial strain of 10%, a dynamic strain of 2%, a frequency of 10 Hz and a temperature of 70° C. according to JIS K-6394. The rolling resistance is better as the value is smaller.

TABLE 1

| | | | | Comparative | Comparative | Comparative | Comparative | Comparative |
|---|---|---|---|---|---|---|---|---|
| | Example 1 | Example 2 | Example 3 | Example 1 | Example 2 | Example 3 | Example 4 | Example 5 |
| NR | 70 | 70 | 70 | 70 | 70 | 70 | 70 | 40 |
| BR1 | | | | 30 | | 30 | | |
| BR2 | 30 | 30 | | | 30 | | 30 | 60 |
| BR3 | | | 30 | | | | | |
| CB1 | | | | 35 | 35 | | | 35 |
| CB2 | 35 | | | | | | | |
| CB3 | | 35 | 35 | | | | | |
| CB4 | | | | | | 35 | | |
| CB5 | | | | | | | 35 | |
| Mooney viscosity | 100 | 80 | 90 | 100 | 115 | 70 | 125 | 130 |
| (Index) | | | | | | | | |
| Tear force | 100 | 100 | 100 | 100 | 100 | 80 | 100 | 100 |
| (Index) | | | | | | | | |
| tan δ | 0.04 | 0.03 | 0.03 | 0.08 | 0.06 | 0.05 | 0.06 | 0.04 |

The pneumatic tire according to the aspect of the present invention can be used as tires having various applications and sizes, for passenger cars, lightweight trucks, trucks, buses or the like, and is particularly suitable as a pneumatic tire requiring low fuel consumption.

What is claimed is:

1. A pneumatic tire comprising a tread rubber which comprises a cap rubber provided at a road surface side and a base rubber provided at its inner periphery side, wherein the base rubber comprises a rubber composition which comprises 100 parts by weight of a diene rubber component containing from 15 to 50 parts by weight of a butadiene rubber or a styrene-butadiene rubber, its molecular end being modified with a modifier, polymerized using an organic lithium catalyst, and from 20 to 50 parts by weight of carbon black having a nitrogen adsorption specific surface area (N₂SA) of from 20 to 40 m²/g and a dibutyl phthalate (DBP) absorption of from 50 to 150 cm³/100 g, and loss tangent (tan δ) of the rubber composition measured at 70° C. is less than 0.05.

2. The pneumatic tire as claimed in claim 1, wherein the modifier comprises at least one selected from a group consisting of a tin compound, a hydroxyl group-containing compound and an amino group-containing compound.
